(19) United States
(12) Patent Application Publication
(10) Pub. No.: US 2018/0369772 A1
(43) Pub. Date: Dec. 27, 2018

(54) Apparatus and method of converting water into usable fuel.

(71) Applicant: G&G Products Family of Companies, LLC, Houston, TX (US)

(72) Inventor: Miller Burke, Houston, TX (US)

(21) Appl. No.: 15/632,273

(22) Filed: Jun. 23, 2017

(51) Int. Cl. B01J 7/02; F02M 21/02; F02M 35/104; C01B 3/04; B01J 19/10

(52) U.S. Cl. CPC B01J 7/02; F02M 21/0206; F02M 21/0221; B01J 2219/0877; F02M 35/104; C01B 3/042; B01J 19/10; F02M 21/029

(57) ABSTRACT

An apparatus and method for converting water into a usable fuel is disclosed. Specifically, the device utilizes a control unit using electronics to create oscillations in tuned metal surrounded by water to atomize the water into its molecular components before being injected into the intake manifold of an internal combustion engine. The invention also has application in creating a reliable supply of helium-3 from water.

### BACKGROUND OF THE INVENTION

The present invention relates to an apparatus and method for converting water into a usable fuel for an internal combustion engine. The invention has multiple applications including running an internal combustion engine solely on water as well as creating a reliable supply helium-3.

It is no secret that humans rely heavily on fossil fuels in their everyday lives. As we consume more oil and natural gas, people have constantly sought to make improvements in fuel efficiency, emissions control, and alternative fuel sources. While there is a considerable amount of prior art that makes use of alternative energy sources like hydrogen and electric fuel cells and solar and wind generators, these energy sources are typically not sufficient to provide necessary power generation alone and often need to be combined in some hybrid fashion to ensure that the appropriate power generation is available.

There have been significant advances in utilizing the hydrolysis of water in conjunction with an internal combustion engine in order to improve fuel efficiency and decrease the emissions of undesired pollutants. U.S. Pat. No. 5,231,954 (the '954 patent), U.S. Pat. No. 6,209,493 B1 (the '493 patent), and U.S. Pat. No. 6,866,756 B2 (‘the '756 patent) all disclose an electrolysis cell that is used to provide hydrogen and oxygen to the fuel system of an internal combustion engine.

The '954 patent, which issued on Aug. 3, 1993, teaches an electrolysis cell for use in connection with a combustion engine for generating hydrogen and oxygen gases which are added to the fuel delivery system as a supplement to the gasoline or other hydrocarbons burned therein. While this patent proposes an electrolysis unit which is relatively simple and easy to install, this resulting device has a number of problems which require considerable maintenance and lead to higher costs associated with installing and using the device.

The '493 patent, which issued on Apr. 3, 2001, discloses a kit that also uses an electrolysis cell to produce hydrogen and oxygen that may either be separated or mixed before the gases are introduced to a vehicle fuel system. While this system further increased fuel efficiency, it still does not have components that are readily removable and replaceable by the end user. The electrodes used in this system also have a relatively small surface area, thereby limiting the amount of hydrogen and oxygen that can be produced.

The '756 patent, which issued on Mar. 15, 2005, claims an electrolyzer that solves many of the problems left unresolved by prior art, but still requires the use of both an aqueous electrolyte solution and the presence of fossil fuels to operate.

All of these prior art systems claim that their benefit derives from a more complete combustion of the fossil fuels by adding gaseous hydrogen to the fuel mixture thereby reducing the amount of soot and carbon monoxide that is consistent with an incomplete combustion cycle. However, each of these systems are complicated by one or more undesirable features. While each successor claims to overcome the deficiencies of its predecessor, all fail to divorce itself from its reliance on both an aqueous electrolyte solution and the presence of fossil fuels for successful operation.

Accordingly, there exists a need for an improved power generating system that is simple to fabricate with end user replaceable components and that is capable of generating enough gaseous hydrogen and oxygen to be able to power an internal combustion engine without an aqueous electrolyte solution or fossil fuels.

The fuel created by the apparatus can also be converted into helium-3 (hereinafter “He3”). He3 is a rare, but naturally occurring isotope of helium. He3 has a variety of applications in homeland security, national security, medicine, industry, and science. However, the world is experiencing a shortage of He3 of such magnitude that federal officials and scientist have expressed concern that the shortage might affect federal investments and threaten certain science fields.

He3 is an isotope of helium and is an inert, non-toxic, non-radioactive gas. Most helium gas is helium-4. The natural abundance of He3, as a fraction of all helium, is only about 1.37 parts per million.

He3 has properties that currently make it in high demand. Like all helium, He3 is nontoxic. He3 also absorbs neutrons. This property has resulted in its widespread use for neutron detection. Neutron detection is a key component of applications in national and homeland security, industry, and science.

Another property that has increased demand for He3 in recent years is the ability to polarize its nucleus. For example, magnetic resonance imaging can take advantage of this property to enable real time visualization of a patient's lung capacity and capability.

He3 also has unique cryogenic properties. Low temperature physicists use a mixture of He3 and Helium 4 to achieve temperatures just a few thousandths of a degree above absolute zero.

Rather than rely on natural abundance, the most common source of He3 in the United States is the U.S. nuclear weapons program, of which it is a byproduct. The federal government produces tritium for use in nuclear warheads. Tritium decays into He3. This mean that the tritium needs of the nuclear war program, not demand for He3 itself, determines the amount of He3 produced. Even if we could produce as much tritium as demand for He3 dictated, users of He3 would have to wait 12.3 years, the half life of tritium, before supply could accurately match demand.

Tritium is also produced naturally in the upper atmosphere by interaction of nitrogen, and, to a lesser extent, oxygen with cosmic rays. After oxidation to water, it takes part in the natural water cycle.

However, before the full potential of natural tritium as a tracer for water movement in natural systems could be explored its distribution was masked by addition of large amounts of so-called ‘bomb tritium’ produced during the surface tests of nuclear weapons. These tests which were mainly performed in the early 1960s, led to an increase of tritium in precipitation over the continents of the northern hemisphere from roughly 5 Tritium Units (TU) to levels of the order of 1000 TU. One TU means a tritium to hydrogen ratio of 10-18:1.

Whereas the addition of bomb tritium to the environment practically eliminated the use of natural tritium as a tracer, it offered a new tool, i.e., the use of the bomb tritium peak as a ‘dye’ that is delivered to natural water systems from the atmosphere on local to global scales. However, there are natural limits to this method because tritium decay and dispersion make it increasingly difficult to identify the bomb peak in groundwater.

These problems can be overcome by using tritium in combination with its decay product He3. Even if most of the tritium has decayed, simultaneous measurement of tritium and tritiogenic He3 (“He3trit”) allow us to identify the tritium peak as the sum of tritium and He3trit and to directly calculate an age from the radioactive mother/daughter ratio (tritium/3He age).

Additionally, studies have shown that helium and tritium are present in water beside ground water and in amounts greater that any of the previous studies showed as possible.

By utilizing the present invention, production of He3 as inexpensive as the cost of the units in manufacturing, materials and personnel for maintenance.

### SUMMARY OF THE INVENTION

The present invention seeks to overcome the shortcomings of the prior art by providing new technologies in areas such as converting water into a usable fuel. Specifically, the device utilizes a control unit using electronics to create oscillations in tuned metal surrounded by water to atomize the water into its molecular components before being injected into some other device.

In one embodiment of the invention, the fuel is injected into the intake manifold of an internal combustion engine. By utilizing this embodiment, the apparatus will be able to generate a continuous power supply without relying on fossil fuels or aqueous electrolyte solutions.

In another embodiment of the invention the fuel can be converted into a reliable supply of He3. In this embodiment, a series of Paul and Pell traps will need to utilized in order to separate the ionized molecules from the neutral He3.

### BRIEF DESCRIPTION OF DRAWINGS

FIG. 1: External view of the resonation chamber

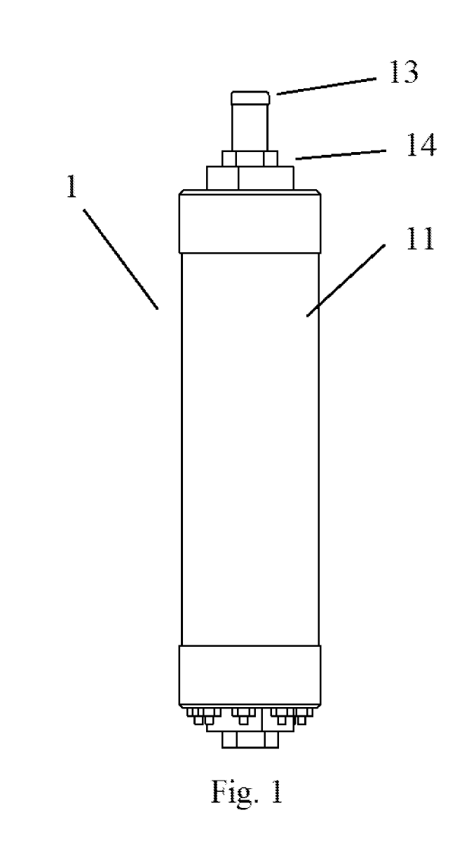

FIG. 2: Transparent view of the resonation chamber

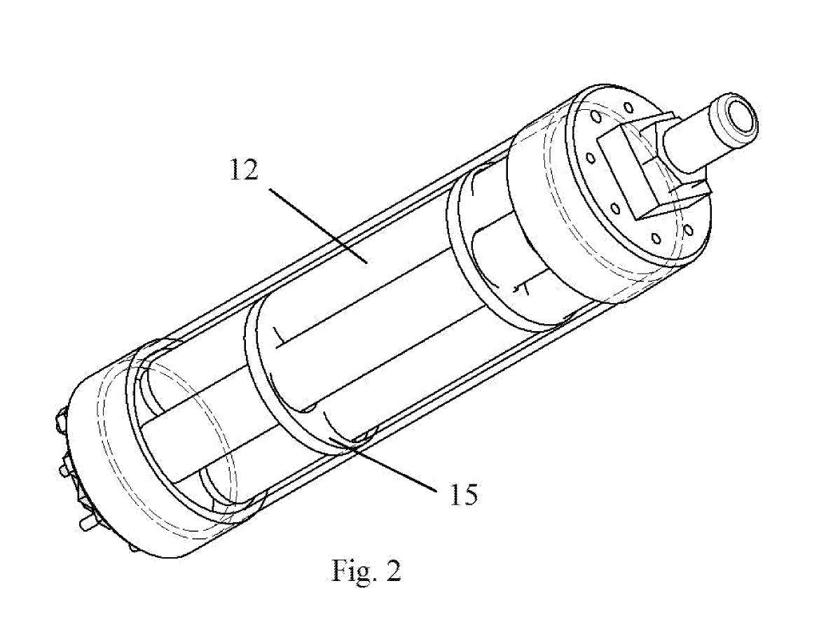

FIG. 3: Cross section of resonation chamber

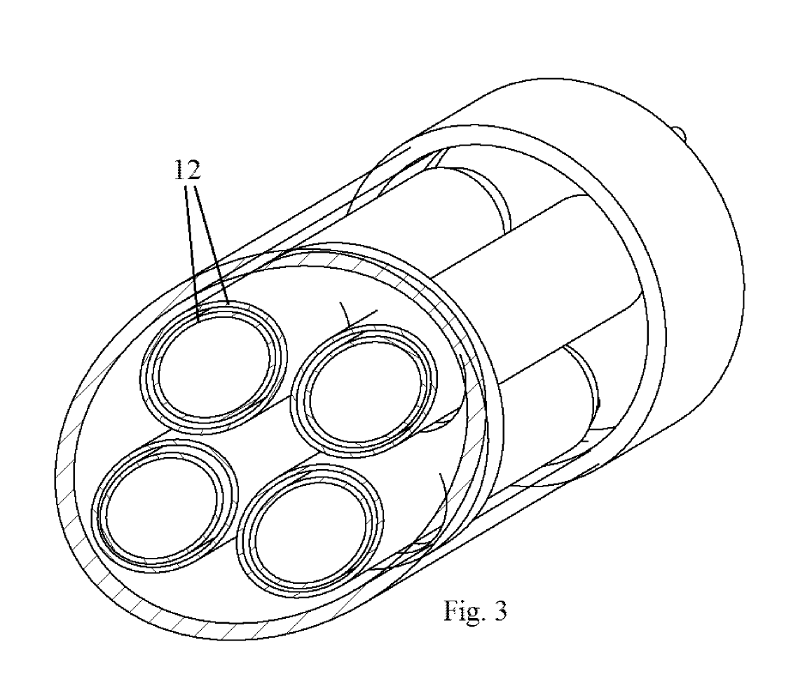

FIG. 4: Exploded view of the resonation chamber

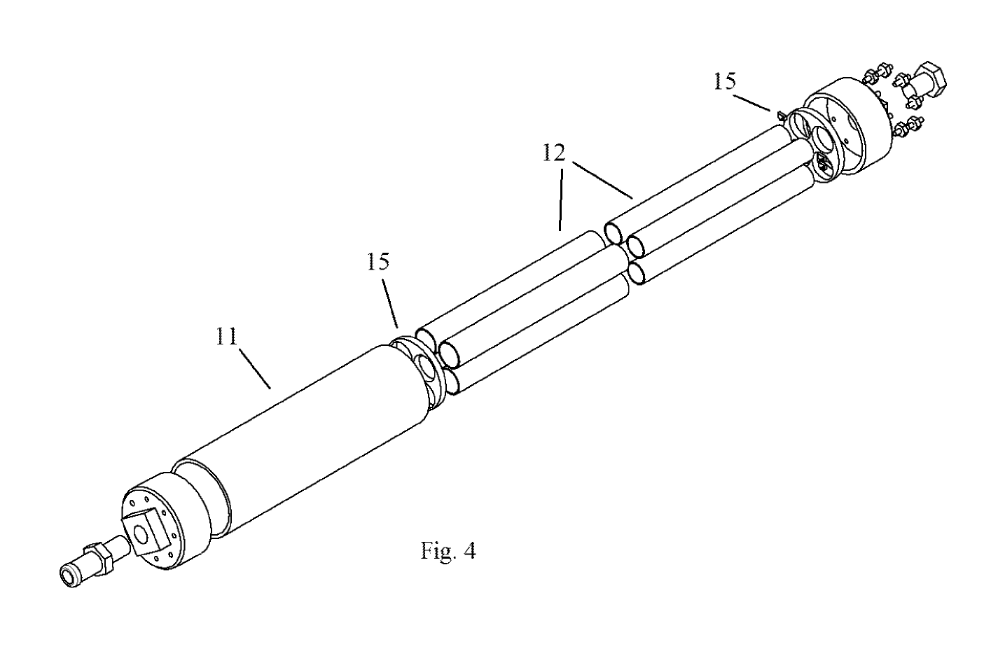

### DETAILED DESCRIPTION OF PREFERRED EMBODIMENTS

The heart of the present invention comprises a fluid conversion apparatus. This apparatus is comprised of a resonation chamber (1) able to hold gasses as thin as Helium (He1) to He3. The resonation chamber is further comprised of a sealed plastic container (11), at least one pair of metal portions (12), and input valve (13) and a gasket (14). The resonation plates or tubes that are individually tuned so that all of them are on the same natural pitch. In a preferred embodiment, the apparatus is made of four pairs of resonation tubes, but any number can be used depending on the desired power output of the apparatus. The preferred embodiment also utilizes resonation tubes.

In a preferred embodiment, the resonation chamber is further comprised of spacing adapters (15) to ensure that the metal portions do not contact each other.

The apparatus is further comprised of a control unit (2). The control unit delivers an electric current to resonation chamber from its power supply to the resonation tubes. The control unit's power supply and resonation tubes should be connected by diodes. Further, the control unit and the resonation tubes must be tuned to the base resonation of the molecules of the fluid. As the resonation tubes transfer the harmonics in the fluid, the fluid will breakdown into its component molecules. Water is an ideal fluid as the water molecule is easily separated into two hydrogen atoms, one oxygen atom, and various daughters of hydrogen and helium when the resonation tubes are tuned to the key of E and the control unit to 82.407 Hz.

Once the fluid is converted it can be used to fuel a variety of mechanical devices including a conventional internal combustion engine tuned for the fuel or a sealed engine using super dense clusters in the excited state to create expansion and contraction.

Before the injection of the Brown's gas and with the absence of fossil fuels, the combustion engine can simply contain air. Normal air consists of primarily nitrogen and oxygen with small concentrations of other trace gases. At these natural levels the air is not combustible. However, by adding the Brown's gas from the resonation chamber to an internal combustion engine via the intake manifold the presence of both oxygen and hydrogen are dramatically increased resulting in a combustible gaseous mixture that ignites with a relatively low initial charge.

Furthermore, by introducing an oxidized combustible (oxygen and hydrogen) into the intake manifold of an internal combustion engine, not only are the shackles of fossil fuels and aqueous electrolyte solutions discarded, but the resulting system also has the added benefit of significantly lowering the combustion chamber's temperatures while raising the overall performance of the engine by increasing the chemical dissolution of the fuel source for the engine.

In another embodiment of the invention the apparatus is further comprised of a series of Paul and Pell traps which are used to separate the oxygen, hydrogen, and helium from each other. The Brown's gas should be channeled through a thin walled polymer or glass tubing contained within a stainless steel containment unit. The He3 will permeate through the tubing into the containment unit that is welded and gasketed.

A magneto-optical trap should then be used to isolate the He3 molecules from the He4 in the container via a stainless steel tube then the cooled and stable He3 is held for use in a second stainless steel container sealed with stainless steel fittings and gaskets.

The Paul and Pell traps can also be used in order to separate negatively and positively charged molecules (hydrogen and oxygen) into separate chambers to salvage gasses not used for fuels into storage for other uses.

What is claimed is:

1. A fluid conversion apparatus capable of converting water into a usable fuel comprising:
a. a resonation chamber further comprising at least one pair of tuned metal portions submerged in water and surrounded by a sealed plastic container where;
i. the tuned metal portions are tuned to the harmonic frequency of water;
ii. the sealed plastic container further comprises an input valve and a gasket; and
iii. the input valve is capable of being connected to a water source; and
b. a first control unit further comprising a first power supply and diodes where;
i. the diodes connect the power supply to the tuned metal portions; and
ii. the first control unit regulates the delivery of the power supply at the same frequency as the tuned metal portions.

2. The apparatus in claim 1 further comprising the gasket being connected to a mechanical device.

3. The apparatus in claim 2 further comprising the mechanical device being an internal combustion engine.

4. The apparatus in claim 3 further comprising the gasket being connected to the internal combustion engine's intake manifold.

5. The apparatus in claim 1 further comprising the water source being an onboard reservoir that is connected to the input valve.

6. The apparatus in claim 1 further comprising multiple fluid conversion apparatuses connected to the same mechanical device.

7. The apparatus of claim 1 further comprising
a. a series of magnets further comprising at least one positively charged magnet and at least one negatively charged magnet;
b. a first containment unit further comprising, a first valve, a tube, a second valve, and a first pump where;
i. the first valve is located on the surface of the first containment unit;
ii. the tube is inside the first containment unit and attached to the gasket;
iii. the series of magnets is connected to the tube at the first valve;
iv. the second valve is capable of connecting to some other device for storing the usable fuel or needing the usable fuel to operate;
v. the first pump is capable of creating a vacuum within the first containment unit; and
vi. the first containment unit is made of stainless steel of at least one sixteenth ( 1/16) inch.

8. The apparatus in claim 7 further comprising the tube being comprised of glass or plastic polymer.

9. The apparatus in claim 7 further comprising the series of magnets being connected to a general waste storage unit.

10. The apparatus in claim 7 further comprising the positively charged magnets being connected to a first waste storage unit.

11. The apparatus in claim 7 further comprising the negatively charged magnets being connected to a second waste storage unit.

12. A fuel storage apparatus comprising:
a. a second containment unit made of stainless steel of at least one sixteenth ( 1/16) inch;
b. a storage chamber inside the second containment unit;
c. a third valve connected to the second containment unit and is capable of attaching to some other device such as the second valve in the apparatus in claim 1 or to some other device needing fuel to operate;
d. a second pump connected to the second containment unit and is capable of creating a vacuum within the first containment unit;
e. a coil wrapped around the second containment unit;
f. a second control unit connected to the coil and further comprising a power supply and a timer:
i. where the timer is programmed to deliver electricity to the coil in a manner such that it will create a changing magnetic field around the fuel storage unit.

13. The apparatus in claim 12 further comprising the coil being oriented in a single starship coil pattern.

14. The apparatus in claim 12 where the coil further comprises multiple starship coils intertwined with each other.

15. A method for converting water into a usable fuel comprising:
a. building the apparatus of claim 1;
b. filling the resonation chamber with water;
c. turning on the power supply in order to supply electricity to the tuned metal portions through the diodes at the same frequency of the tuned metal portions and the harmonic frequency of water;
d. so that the tuned metal portions will resonate with the water thereby stripping the water to its elemental gaseous parts;
e. the resulting gas can then escape the sealed plastic container through the gasket and into the mechanical device;
f. some energy capable of igniting the gaseous mixture is introduced to the gaseous mixture in the mechanical device to incite a combustion cycle.

16. A method for converting water into a usable fuel comprising:
a. building the apparatus of claim 2;
b. filling the resonation chamber with water;
c. turning on the power supply in order to supply electricity to the tuned metal portions through the diodes at the same frequency of the tuned metal portions and the harmonic frequency of water;
d. so that the tuned metal portions will resonate with the water thereby stripping the water to its elemental gaseous parts;
e. the resulting gas can then escape the sealed plastic container through the gasket and into the mechanical device;
f. some energy capable of igniting the gaseous mixture is introduced to the gaseous mixture in the mechanical device to incite a combustion cycle.

17. A method for converting water into a usable fuel comprising:
a. building the apparatus of claim 3;
b. filling the resonation chamber with water;
c. turning on the power supply in order to supply electricity to the tuned metal portions through the diodes at the same frequency of the tuned metal portions and the harmonic frequency of water;
d. so that the tuned metal portions will resonate with the water thereby stripping the water to its elemental gaseous parts;
e. the resulting gas can then escape the sealed plastic container through the gasket and into the mechanical device;
f. some energy capable of igniting the gaseous mixture is introduced to the gaseous mixture in the mechanical device to incite a combustion cycle.

18. A method for converting water into a usable fuel comprising:
a. building the apparatus of claim 4;
b. filling the resonation chamber with water;
c. turning on the power supply in order to supply electricity to the tuned metal portions through the diodes at the same frequency of the tuned metal portions and the harmonic frequency of water;
d. so that the tuned metal portions will resonate with the water thereby stripping the water to its elemental gaseous parts;
e. the resulting gas can then escape the sealed plastic container through the gasket and into the mechanical device;
f. some energy capable of igniting the gaseous mixture is introduced to the gaseous mixture in the mechanical device to incite a combustion cycle.

19. A method for converting water into a usable fuel comprising:
a. building the apparatus in any of claim 7;
b. filling the resonation chamber with water;
c. turning on the pump attached to the first containment unit to create a vacuum in the first containment unit;
d. turning on first power supply in order to supply electricity to the tuned metal portions through the diodes at the same frequency of the tuned metal portions and the harmonic frequency of water;
e. so that the tuned metal portions will resonate with the water thereby stripping the water to its elemental gaseous parts;
f. the gas can then escape the sealed plastic container through the gasket and into the tube;
g. where the series of magnets will then attract and separate all charged elemental gaseous parts and depositing those charged elemental parts into whatever waste storage unit is connected to the magnets; and
h. thereby leaving only the neutral elemental parts which constitute the usable in the tube which will permeate through the tube into the first containment unit.

20. A method for converting water into a usable fuel comprising:
a. building the apparatus in any of claim 8;
b. filling the resonation chamber with water;
c. turning on the pump attached to the first containment unit to create a vacuum in the first containment unit;
d. turning on first power supply in order to supply electricity to the tuned metal portions through the diodes at the same frequency of the tuned metal portions and the harmonic frequency of water;
e. so that the tuned metal portions will resonate with the water thereby stripping the water to its elemental gaseous parts;
f. the gas can then escape the sealed plastic container through the gasket and into the tube;
g. where the series of magnets will then attract and separate all charged elemental gaseous parts and depositing those charged elemental parts into whatever waste storage unit is connected to the magnets; and
h. thereby leaving only the neutral elemental parts which constitute the usable in the tube which will permeate through the tube into the first containment unit.

21. A method for converting water into a usable fuel comprising:
a. building the apparatus in any of claim 9;
b. filling the resonation chamber with water;
c. turning on the pump attached to the first containment unit to create a vacuum in the first containment unit;
d. turning on first power supply in order to supply electricity to the tuned metal portions through the diodes at the same frequency of the tuned metal portions and the harmonic frequency of water;
e. so that the tuned metal portions will resonate with the water thereby stripping the water to its elemental gaseous parts;
f. the gas can then escape the sealed plastic container through the gasket and into the tube;
g. where the series of magnets will then attract and separate all charged elemental gaseous parts and depositing those charged elemental parts into whatever waste storage unit is connected to the magnets; and
h. thereby leaving only the neutral elemental parts which constitute the usable in the tube which will permeate through the tube into the first containment unit.

22. A method for converting water into a usable fuel comprising:
a. building the apparatus in any of claim 10;
b. filling the resonation chamber with water;
c. turning on the pump attached to the first containment unit to create a vacuum in the first containment unit;
d. turning on first power supply in order to supply electricity to the tuned metal portions through the diodes at the same frequency of the tuned metal portions and the harmonic frequency of water;
e. so that the tuned metal portions will resonate with the water thereby stripping the water to its elemental gaseous parts;
f. the gas can then escape the sealed plastic container through the gasket and into the tube;
g. where the series of magnets will then attract and separate all charged elemental gaseous parts and depositing those charged elemental parts into whatever waste storage unit is connected to the magnets; and
h. thereby leaving only the neutral elemental parts which constitute the usable in the tube which will permeate through the tube into the first containment unit.

23. A method for converting water into a usable fuel comprising:
a. building the apparatus in any of claim 11;
b. filling the resonation chamber with water;
c. turning on the pump attached to the first containment unit to create a vacuum in the first containment unit;
d. turning on first power supply in order to supply electricity to the tuned metal portions through the diodes at the same frequency of the tuned metal portions and the harmonic frequency of water;
e. so that the tuned metal portions will resonate with the water thereby stripping the water to its elemental gaseous parts;
f. the gas can then escape the sealed plastic container through the gasket and into the tube;
g. where the series of magnets will then attract and separate all charged elemental gaseous parts and depositing those charged elemental parts into whatever waste storage unit is connected to the magnets; and
h. thereby leaving only the neutral elemental parts which constitute the usable in the tube which will permeate through the tube into the first containment unit.
